(19) United States
(12) Patent Application Publication
(10) Pub. No.: US 2023/0222455 A1
(43) Pub. Date: Jul. 13, 2023

(54) SENSOR DRIVEN SYSTEM FOR MANAGING THE LOGISTICS BEHIND REUSABLE OBJECTS

(71) Applicant: LimeLoop Inc., Tucson, AZ (US)

(72) Inventors: Chantal Emmanuel, Lagrangeville, NY (US); Ashley Etling, Tucson, AZ (US)

(73) Assignee: LimeLoop Inc., Tucson, AZ (US)

(21) Appl. No.: 18/095,029

(22) Filed: Jan. 10, 2023

Related U.S. Application Data
(60) Provisional application No. 63/298,627, filed on Jan. 11, 2022.

(51) Int. Cl. G06Q 10/30; G06Q 10/0833; G06Q 10/0832; H04W 4/38; H04W 4/029; H04W 4/80

(52) U.S. Cl. CPC G06Q 10/30; G06Q 10/0832; G06Q 10/0833; H04W 4/029; H04W 4/38; H04W 4/80

(57) ABSTRACT

A sensor-driven system for managing the logistics behind reusable objects is disclosed herein. The system offers a fully integrated and informed experience from the time a product is ordered by a sender to when the package is returned by a recipient. Senders use this technology to track their fleet, capture valuable data, enable predictive analytics, and better protect delivered packages. Recipients utilize this system to reduce package frustration while minimizing waste and environmental impact.

### FIELD OF THE EMBODIMENTS

The field of the invention and its embodiments relate to a sensor-driven system for managing the logistics behind reusable objects.

### BACKGROUND OF THE EMBODIMENTS

Product delivery businesses traditionally rely on conventional packaging, such as cardboard boxes or plastic wrapping, to package products for delivery to an end recipient. Conventional packaging is typically single use, and thus creates waste and environmental damage when the recipient discards the packaging once the product has been delivered. Moreover, conventional packaging lacks sufficient temperature and humidity insulation, and thus is not suitable for packaging fresh produce or frozen items.

Temperature insulated packaging may be employed to contain fresh produce or frozen items for delivery. Moreover, such cooler bags may be reused for many subsequent deliveries, and thus eliminates unnecessary waste and lessens the environmental impact. Unlike conventional packaging, reusable cooler bags are expensive to produce. Moreover, such temperature insulated packaging often fails to account for humidity concerns associated with some products. Therefore, there is a need for improved methods and systems for efficient deployment and tracking of reusable bags or packages that reduce the environmental harm associated with conventional packaging and that can manage numerous parameters for the product, such as temperature and humidity.

### Examples of Related Art Include

TW202041432A, JP2010143640A, and CN107512454A describe a reusable packing box designed to alleviate environmental waste, improve operational efficiency, and provide maximum article protection.

IN201911022753A relates to a method for delivery of goods. Specifically, the reference relates to a method for the secure delivery of a purchased item by means of a smart packing box that detects tampering with the parcel carrying the item and informs the parties involved in selling and purchasing. The smart box also includes a smart circuit that comprises a global positioning system, a global system for mobile communication, sensors, and a microcontroller.

CN111422494A relates to a reusable package. The reusable package is detachably connected with a receiving and sending terminal. The reusable package comprises a package body, a package lock component, a terminal locking piece and a RFID tag. The package lock component is mounted in combination with the package body, and controls, opening, closing and locking of the package. The terminal locking piece is mounted in combination with the package body. The receiving and sending terminal comprises a control connector and a terminal locking device, when the reusable package is connected with the receiving and sending terminal, the control connector is connected with the package lock component, and the terminal locking device is connected with the terminal locking piece.

US20190034873A1 describes an apparatus, system, and method for real-time package tracking and delivery security. In particular, the reference relates to a method for tracking the real-time location of packages and generating real-time updates and geolocation displays accessible to users.

CN106829122A describes a logistics system comprising a recyclable express delivery packaging box. The logistics system is mainly based on modulization series design under the cloud computing management of the Internet, and the recyclable packaging box system and thoroughly eliminates waste and garbage problems of express delivery packaging material. The logistics system comprises an integrated RRID module, an automatic identification equipment system, and a cloud management, transferring, self-inspection error correction and tracking and monitoring system. The integrated RRID module combines with the specially designed QR code, bar code and label placement area to build an unobstructed bridge between the logistics and the cloud information flow. The automatic identification equipment system is professional and builds the bridge with the cloud Internet based on an RRID electronic tag to realize the genuine Internet of Things system. On the basis, the cloud management, transferring, self-inspection error correction and tracking and monitoring system solves the practical problems that as the current express delivery packaging is not standardized, management is in chaos, and the packaging material is disposable to cause serious waste and environmental pollution.

CN106742720A describes a reusable express packaging box provided with coded locks and an unlocking process.

CN104302555B describes a smart package and monitoring system having a status indicator and a method of making the same. The smart package includes an electronic sensor monitoring tag having re-usable electronic circuitry and a power source along with a conductive grid printed on a thin flexible substrate and connected to the tag so the tag and grid are in electrical continuity to form a monitoring device. The conductive grid is aligned with an opening of the smart package. The smart package can also include an optical ink indicator configured to display the status of the package. A multiplexer can be used to connect the tag to the conductive grid. The conductive grid can include capacitive sensors formed on a thin plastic layer and positioned so as to form a capacitive element with the conductive side of the blister.

Some similar systems exist in the art. However, their means of operation are substantially different from the present disclosure, as the other inventions fail to solve all the problems taught by the present disclosure.

### SUMMARY OF THE EMBODIMENTS

The present invention and its embodiments relate to a sensor-driven system for managing the logistics behind reusable objects.

A first embodiment of the present invention describes a sensor-driven system for managing the logistics behind reusable objects. The system generally includes a reusable package, a computing device, and a database. The reusable package includes one or more sensors configured to track parameters of the reusable package during the sending and receiving of a package. The reusable package also includes a battery component or ambient power technology configured to supply power to the one or more sensors, a transmitter configured to transmit the parameters to a receiver of a computing device, a microcontroller configured to manage behavior of the one or more sensors, and a proximity connection technology including but limited to a near-field communication (NFC) antenna configured to allow a user to engage the computing device to interact with the one or more sensors.

The computing device includes at least a receiver configured to receive the parameters from the transmitter of the reusable package and transmit the data to software. The software is configured to transmit the data to a database. The database is configured to store the parameters.

In some embodiments, the reusable package further comprises a thermometer that is configured to determine a current temperature within the reusable package, a reed switch or a photocell that is configured to determine an open or closed status of the reusable package, and/or a global positioning system (GPS) or Bluetooth Low Energy (BLE) component that is configured to determine a current location of the reusable package. As such, the parameters may include, but are not limited to, a tracking number associated with the reusable package, a current humidity level within the reusable package, a minimum humidity level within the reusable package during the journey, a maximum humidity level within the reusable package during the journey, an open status of the reusable package, a time period from when the reusable package was opened, a current temperature within the reusable package, a minimum temperature within the reusable package during the journey, a maximum temperature within the reusable package during the journey, a current location of the reusable package, and/or the level of acceleration, vibration, or shock the reusable package currently is or was experiencing during the journey.

In some examples, the transmitter is a Bluetooth transmitter or a Bluetooth Low Energy transmitter. In other examples, each of the sensors may be a proximity capacitive sensor, a photoelectric sensor, an ambient light sensor, an optical proximity sensor, or a capacitive touch sensor. Further, the transmitter is configured to transmit the parameters to the database.

Additionally, in some examples, the software is further configured to display information associated with the reusable package during the journey. Examples of this information include: data analysis associated with the reusable package during the journey, sustainability statistics associated with the reusable package during the journey (e.g., environmental impact savings associated with the reusable packaging), logistics features associated with the reusable package during the journey, and/or predictive analytics associated with the reusable package. Further, the software allows for integration with APIs to automate order imports, automate shipping and return processes, and allow for direct recipient communication.

A second embodiment of the present invention describes the reusable package. The reusable package includes one or more sensors configured to track parameters of the reusable package during a journey, a thermometer configured to determine a current temperature within the reusable package, a reed switch or a photocell configured to determine an open or closed status of the reusable package, the location component configured to determine a current location of the reusable package, a power storage component configured to supply power to the one or more sensors, a transmitter configured to transmit the parameters to a receiver of a computing device, a microcontroller configured to manage behavior of the one or more sensors, and the NFC antenna configured to allow a user to engage the computing device to interact with the one or more sensors. The parameters include a tracking number associated with the reusable package, a current humidity level within the reusable package, a minimum humidity level within the reusable package during the journey, a maximum humidity level within the reusable package during the journey, an open status of the reusable package, a time period from when the reusable package was opened, a current temperature within the reusable package, a minimum temperature within the reusable package during the journey, a maximum temperature within the reusable package during the journey, a current location of the reusable package, and/or the level of acceleration, vibration, or shock the reusable package currently is or was experiencing during the journey.

The receiver of the computing device is configured to receive the parameters from the transmitter of the reusable packaging and transmit the data to software. Moreover, the software is configured to transmit the data to a database and the database is configured to store the parameters. The software is further configured to display information associated with the reusable package during the journey, where the information includes: data analysis associated with the reusable package during the journey, sustainability statistics associated with the reusable package during the journey, logistics features associated with the reusable package during the journey, and predictive analytics associated with the reusable package.

### BRIEF DESCRIPTION OF THE DRAWINGS

FIG. 1 depicts a schematic diagram of a method executed by a system, according to at least some embodiments disclosed herein.

FIG. 2 depicts a schematic diagram of various components of a reusable package, according to at least some embodiments disclosed herein.

FIG. 3 depicts a block diagram of a system, according to at least some embodiments disclosed herein.

FIGS. 4A - 4G depict schematic diagrams of information associated with a reusable packages journey displayed on a user interface or via a dashboard of a computing device, according to at least some embodiments disclosed herein.

FIG. 5 depicts a schematic diagram associated with foldability of a reusable package, according to at least some embodiments disclosed herein.

FIG. 6 depicts a schematic diagram associated with the foldability of the reusable package and is a continuation of FIG. 5, according to at least some embodiments disclosed herein.

FIG. 7 depicts another schematic diagram associated with a reusable package, according to at least some embodiments disclosed herein.

FIGS. 8 - 10 depict images associated with the foldability of the reusable package, according to at least some embodiments disclosed herein.

FIG. 11 depict schematic diagrams associated with a folded reusable package, according to at least some embodiments disclosed herein.

FIG. 12 depicts a block diagram of components of a computing device included in the system of FIG. 3, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

The process of sending and receiving goods is dated. Rather than creating a solution that fits the needs of the e-commerce economy, the instant invention took the process by which wholesale orders are shipped from a warehouse location to a store location and applied it to individual consumers. On the packaging side, conventional single-use packaging is wasteful and frustrating. Software solutions require the use of several different systems to complete one e-commerce order fulfillment. The instant invention offers a fully-integrated and informed experience from the time a product is sent out from a sender location in reusable packaging to when the shipper is returned. Senders may utilize this technology to track their fleet, capture valuable data, enable predictive analytics, and better protect delivered packages. By using the technology of the instant invention, recipients reduce package frustration, while minimizing waste and environmental impact.

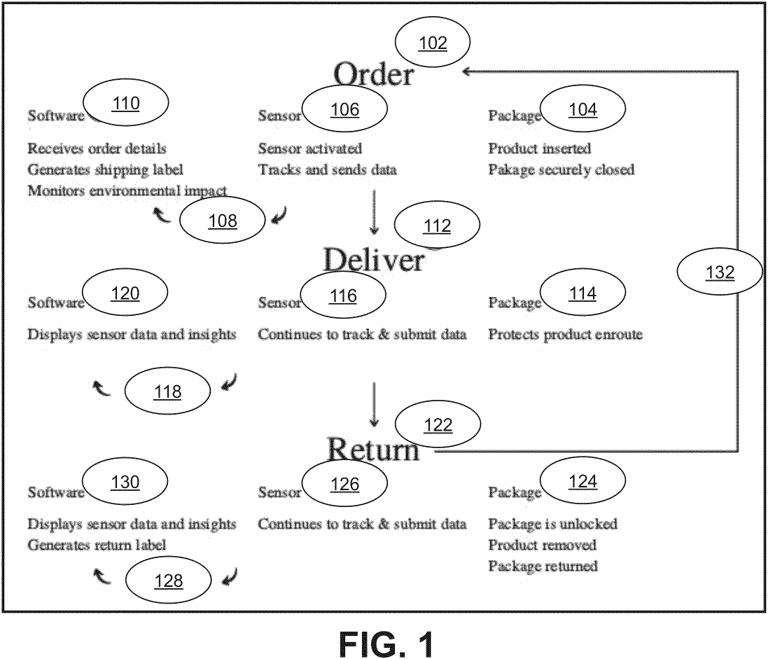

Specifically, FIG. 1 depicts a schematic diagram of a method executed by a system. The method described herein includes three main process steps: (1) order of a product (e.g., a process step 102), (2) delivery of the product using reusable packaging 148 (e.g., a process step 112), and (3) return of the reusable packaging 148 (e.g., a process step 122).

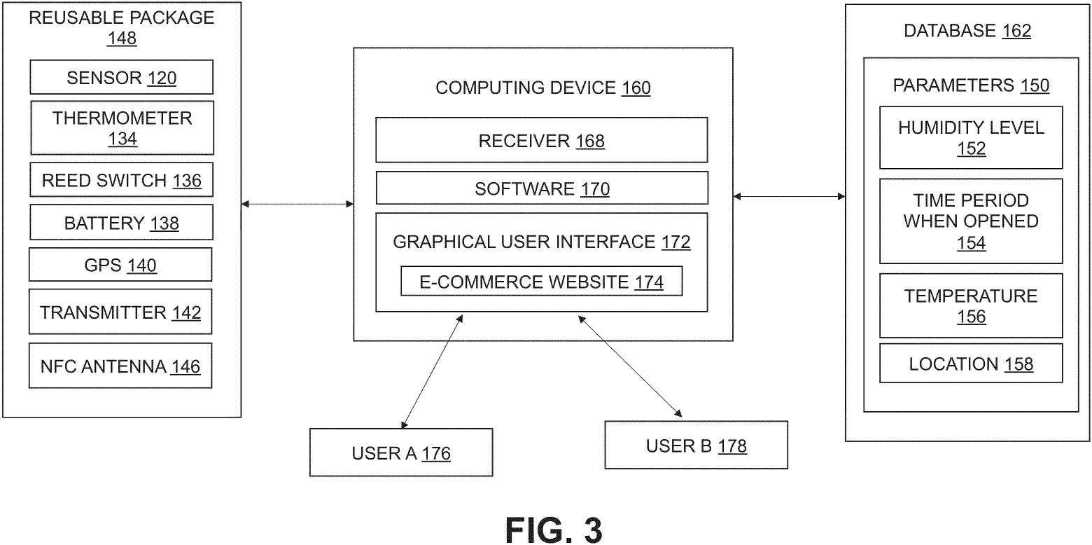

As shown in FIG. 1, at the order process step 102, an order for a product is received from a sender via an e-commerce website 174 of FIG. 3. Software 170 of FIG. 3 is configured to receive the order details and generate a shipping label (e.g., a process step 110). The product is inserted into the reusable packaging 148 (e.g., a process step 104). One or more sensors 120 of the reusable packaging 148 are activated and are configured to track and transmit relevant data associated with the reusable packaging 148 (e.g., a process step 106 and a process step 108). Further, the software 170 is configured to monitor an environmental impact of the reusable packaging 148 (e.g., a process step 110) during the journey. Further, data from one or more sensors 120 is delivered to a database 162 of FIG. 3 and is displayed via a graphical user interface (GUI) 172 of a computing device 160.

The delivery process step 112 includes delivering the reusable packaging 148 housing the product to an end recipient. This process step includes ensuring the reusable packaging 148 protects the product enroute to its final destination (e.g., a process step 114). Further, the one or more sensors 120 of the reusable packaging 148 are configured to continually track and transmit relevant data associated with the reusable packaging 148 (e.g., a process step 116 and a process step 118). Additionally, the software 170 is configured to display the sensor data and relevant insights (e.g., a process step 120) to the user (e.g., via the GUI 172 of the computing device 160).

The return process step 122 includes the reusable packaging 148 being unlocked when it reaches the intended end recipient (e.g., a process step 124). Further, the process step 124 includes the intended recipient removing the product from the reusable packaging 148 and returning the reusable packaging 148 to the sender. The one or more sensors 120 of the reusable packaging 148 are configured to continually track and transmit relevant data associated with the reusable packaging 148 (e.g., a process step 126 and a process step 128). Additionally, the software 170 is configured to display the sensor data and insights via the GUI 172 of the computing device 160, as well as generate a return label (e.g., a process step 130). It should be appreciated that the same reusable packaging 148 is used over and over again to perform the cycle depicted in FIG. 1 (e.g., as shown by a process step 132).

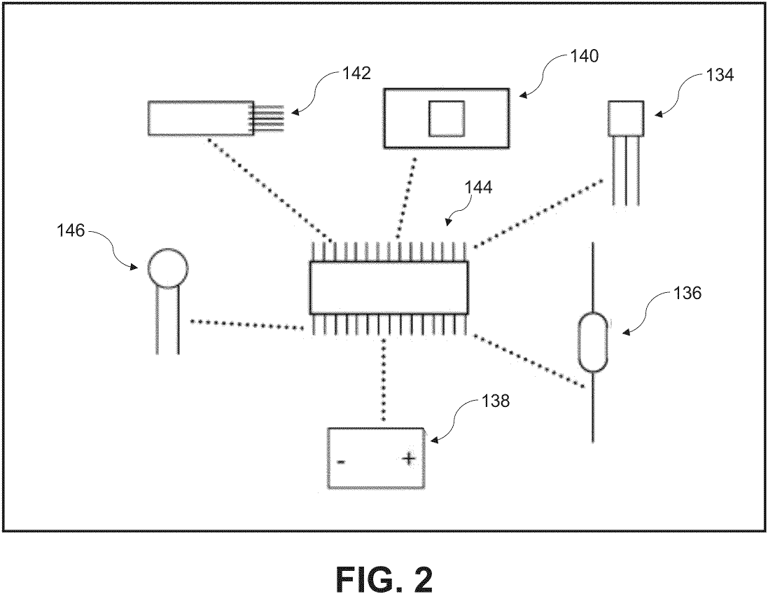

FIG. 2 depicts a schematic diagram of various components of the reusable packaging 148. As shown in FIG. 2, the components of the reusable packaging 148 may include, but are not limited to, a transmitter 142 (e.g., that transmits data from a microcontroller 144 to a cloud), a GPS component 140 that tracks a location of the reusable packaging 148, a thermometer 134 that tracks a temperature of the reusable packaging 148, a reed switch 136 that uses magnetic proximity to a monitor to determine an open status of the reusable packaging 148, a battery component 138 that powers the one or more sensors 120, a photocell 146 (which is alternative to the reed switch 136 and uses light levels to monitor the open status of the reusable packaging 148), and/or the microcontroller 144 (which is programmed to manage behavior of the one or more sensors 120 of the reusable packaging 148).

It should be appreciated that though the transmitter 142 may be a Bluetooth transmitter or a Bluetooth Low Energy (LE) transmitter, among others not explicitly listed herein. In some examples, the reusable packaging 148 may also include a near-field communication (NFC) antenna 146 that is configured to allow a user to engage the computing device 160 to interact with the one or more sensors 120. Further, it should be appreciated that each of the one or more sensors 120 may be a proximity capacitive sensor, a photoelectric sensor, an ambient light sensor, an optical proximity sensor, a capacitive touch sensor, among others not explicitly listed herein.

FIG. 3 depicts a block diagram of a system, according to at least some embodiments disclosed herein. In general, the system includes the reusable packaging 148, the computing device 160, and the database 162.

The reusable packaging 148 may comprise numerous sizes and configurations. For example, a first configuration of the reusable packaging 148 is approximately 8 inches x 11 inches x 2 inches, is made using recycled materials, is soft, includes one interior pocket, and includes an exterior transparent pocket to insert a shipping label. A second configuration of the reusable packaging 148 is approximately 12 inches x 15 inches x 4 inches, is made using recycled materials, is soft, includes one interior pocket, and includes an exterior transparent pocket to insert a shipping label. A third configuration of the reusable packaging 148 is approximately 12 inches x 15 inches x 6 inches when folded, approximately 24 inches x 15 inches x 6 inches when expanded, is made using recycled materials, is soft, includes one interior pocket, and includes an exterior transparent pocket to insert a shipping label. A fourth configuration of the reusable packaging 148 is approximately 14.5 inches x 10.5 inches x 12 inches, is made using recycled materials, is rigid, and includes an exterior transparent pocket to insert a shipping label. Though these configurations have been described, other configurations, including customized configurations, are contemplated herein.

As explained, the reusable packaging 148 may comprise a soft or tough exterior to protect the contents held therein. In some examples, the reusable packaging 148 may comprise a polycarbonate sheet material, a honeycomb board material, a polyethylene sheet material, and/or a polyethylene foam material, among others. The reusable packaging may comprise a zipper or fixation component to assist the reusable packaging in maintaining a closed state when not in use. Moreover, the reusable packaging 148 may comprise a locking mechanism (e.g., digital or analog) to maintain a closed or locked state of the packaging during transit.

In examples, the computing device 160 may be a computer, a laptop computer, a smartphone, and/or a tablet, among other examples not explicitly listed herein. As explained in reference to FIG. 2, the reusable packaging 148 includes numerous components, such as: the one or more sensors 120, the thermometer 134, the reed switch 136, the battery component 138, the GPS component 140, the transmitter 142, and the NFC antenna 146.

The computing device 160 may include a receiver 168 such that the computing device 160 may receive data associated with parameters 150 from reusable packaging 148. These parameters may include: a tracking number associated with the reusable packaging 148, a current humidity level within the reusable packaging 148, a minimum humidity level within the reusable packaging 148 during the journey, a maximum humidity level within the reusable packaging 148 during the journey, an open status of the reusable packaging 148, a time period when the reusable packaging 148 was opened, a current temperature within the reusable packaging 148, a minimum temperature within the reusable packaging 148 during the journey, a maximum temperature within the reusable packaging 148 during the journey, a current location of the reusable packaging 148, and/or how jostled the reusable packaging 148 currently is or was during the journey, among others.

The receiver 168 may transmit this data to the software 170 executed on the computing device 160. The software 170 may transmit this data to the database 162 for storage. In some examples, the software 170 may be an engine, an application, a service, or a software platform executable on the computing device 160. In other examples, the transmitter 142 of the reusable packaging 148 may transmit the data directly to the database 162.

As explained, the reusable packaging 148 and the one or more sensors 120 begins its journey once an order is placed by a sender via the e-commerce website 174. The reusable packaging 148 is delivered to the recipient while being monitored via the software 170 and the one or more sensors 120. Upon receipt by the end recipient, the end recipient can unlock the reusable packaging 148 and return the reusable packaging 148 empty or with product to the sender to be used again and again.

Specifically, the one or more sensors 120 are embedded inside of the reusable packaging 148. The one or more sensors 120 periodically check a state or status of the reusable packaging 148 (e.g., an open state, a closed state, etc.) and transmit the data to the receiver 168 or the database 162.

The computing device 160 may also include the GUI 172. A user A 176 and/or a user B 178 may interact with the GUI 172 on the computing device 160 to access the e-commerce website 174, which may display information associated with the reusable packaging 148. The information may be displayed via text, graphics, charts, etc. such that the sender and the receiver/recipient can leverage this software 170 to view: data analysis, sustainability statistics, logistics features, and predictive analytics. In some examples, stakeholders (e.g., the user A 176 or the user B 178) may leverage the software 170 to view the parameters 150 and to track the location of the reusable packaging 148, as well as the environmental impact savings associated with the reusable packaging 148. In fact, in some examples, the one or more sensors 120 may be used to track the environment of stationary containers, like kiosks, shipping containers, pallets, and mailboxes.

As such, the present invention combines the reusable packaging 148, the one or more sensors 120, and the software 170 to create an open network that various stakeholders can leverage to support their needs. Thus, the present invention seeks to provide a logistic solution that provides the ability or means to perform various tasks in a singular location, such as: managing orders, creating shipping labels, tracking packages, tracking fleets, engaging in predictive analytics, communicating with recipients, managing returns, tracking an environmental impact, and minimizing waste, among others.

The software 170 also allows for: integration with e-commerce APIs to automate order imports, integration with DC APIs to automate shipping and return processes, and direct recipient communication (including automated return shipper messaging, brand customizable event trigger messaging, and predictive up-sale, etc.). Specifically, in some embodiments, the software 170 may contain one or more algorithms (e.g., machine learning or artificial intelligence) to assist in the process steps described herein.

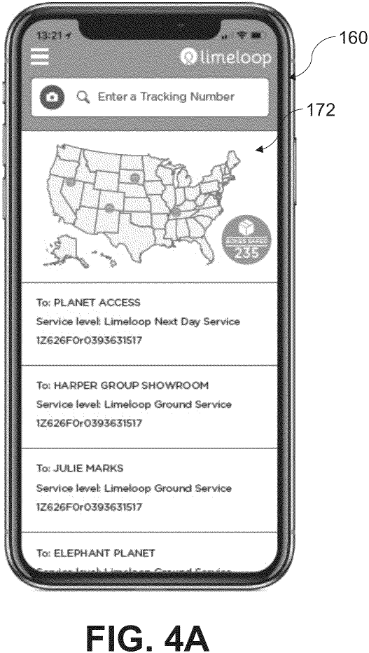

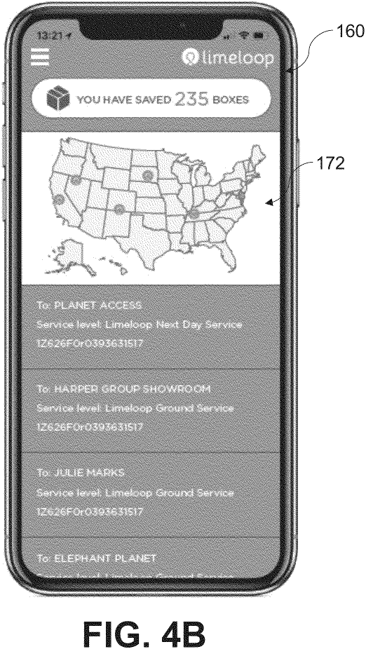

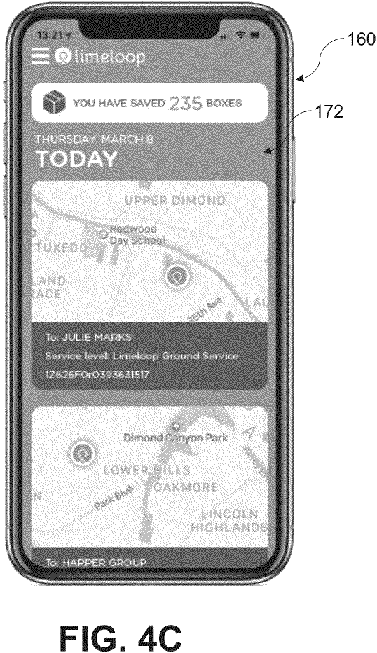

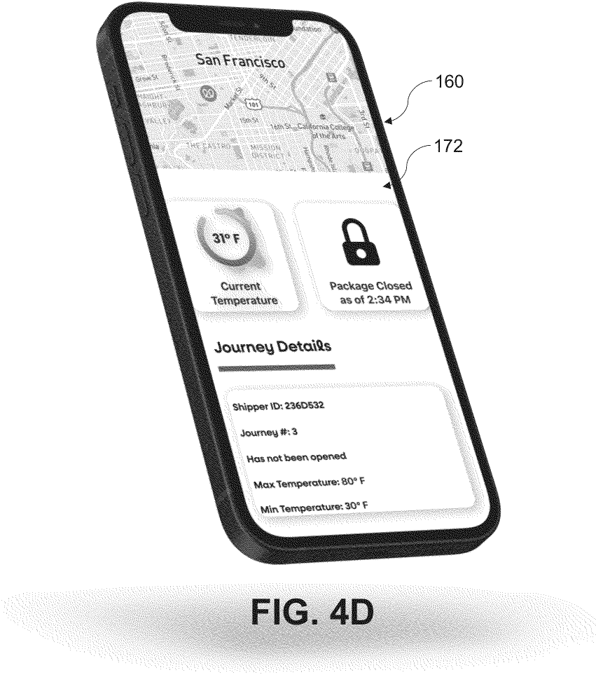

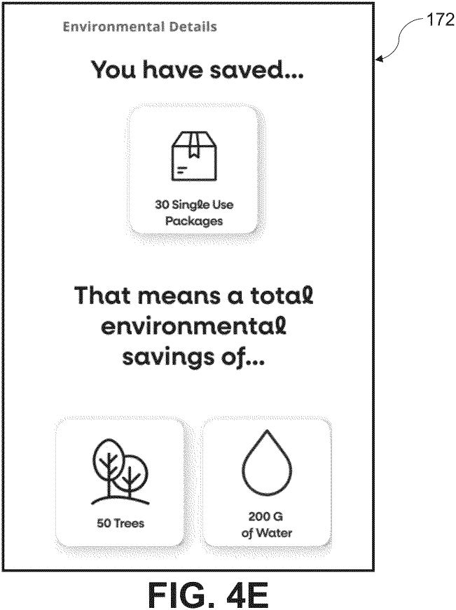

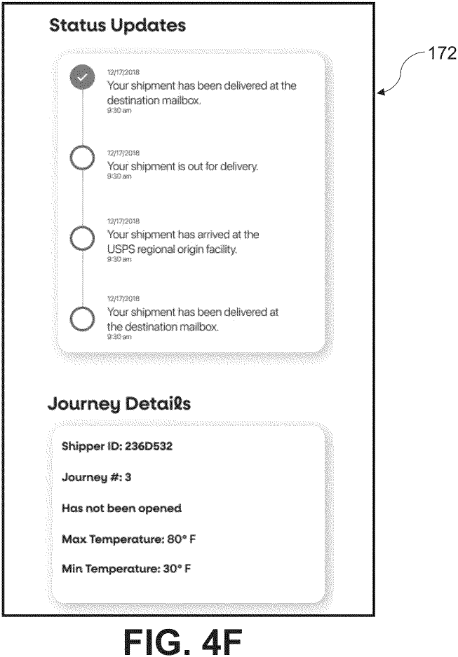

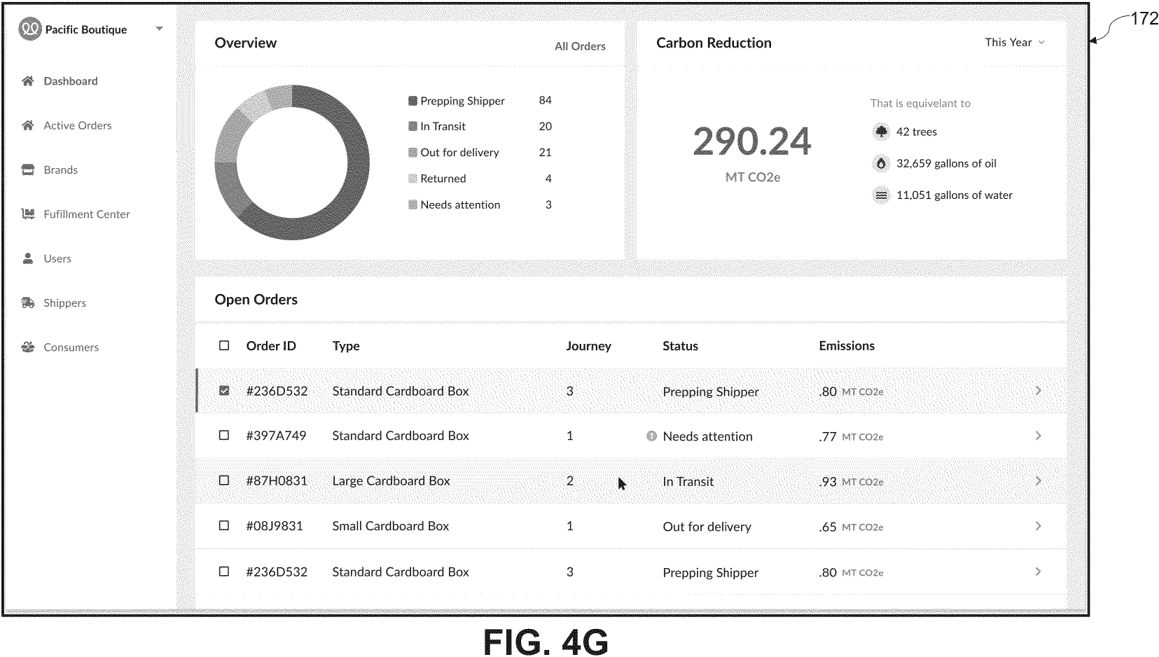

When the user (e.g., the user A 176) interacts with the GUI 172 of the computing device 160, the user A 176 may enter a tracking number associated with the reusable packaging 148 to identify a current and real-time location of the reusable packaging 148, as shown in FIG. 4A -FIG. 4C. Moreover, as shown in FIG. 4D, the information associated with the reusable packaging 148 may include journey details or parameters from the sending party to the receiving party. Moreover, as shown in FIG. 4E, this information may alternatively or additionally include the environmental details associated with the reusable packaging 148, such as a quantity of packages, a quantity of trees, and/or an amount of water that was saved by using the reusable packaging 148. This information may alternatively or additionally include real-time status updates of the reusable packaging 148, as shown in FIG. 4F. Additional information is shown in FIG. 4G, such as the amount of carbon reduction associated with the reusable packaging 148 (e.g., “290.24 MT CO₂e, equivalent to 42 trees, 32,659 gallons of oil, and 11,051 gallons of water”).

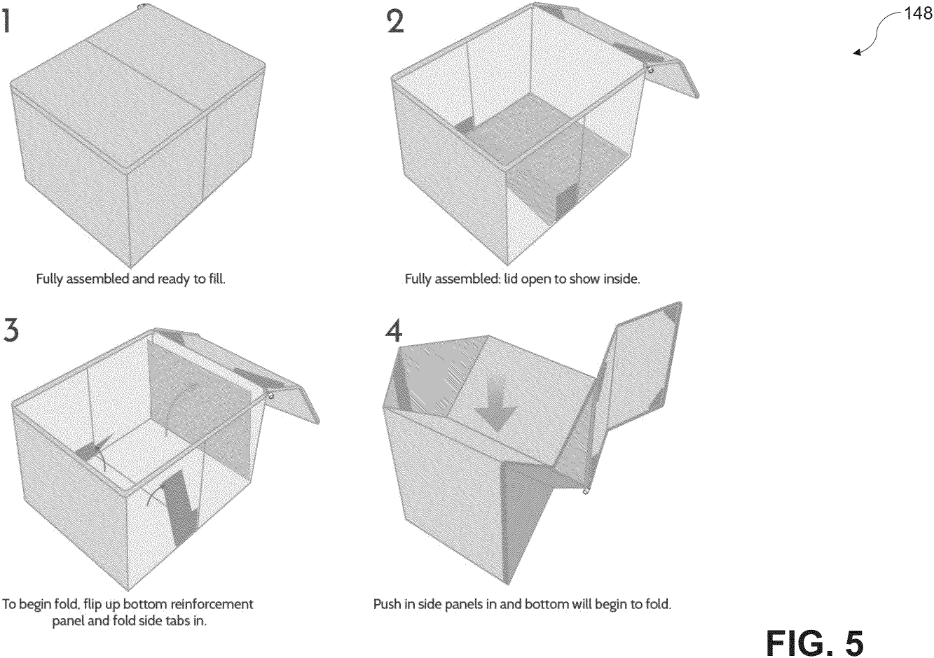

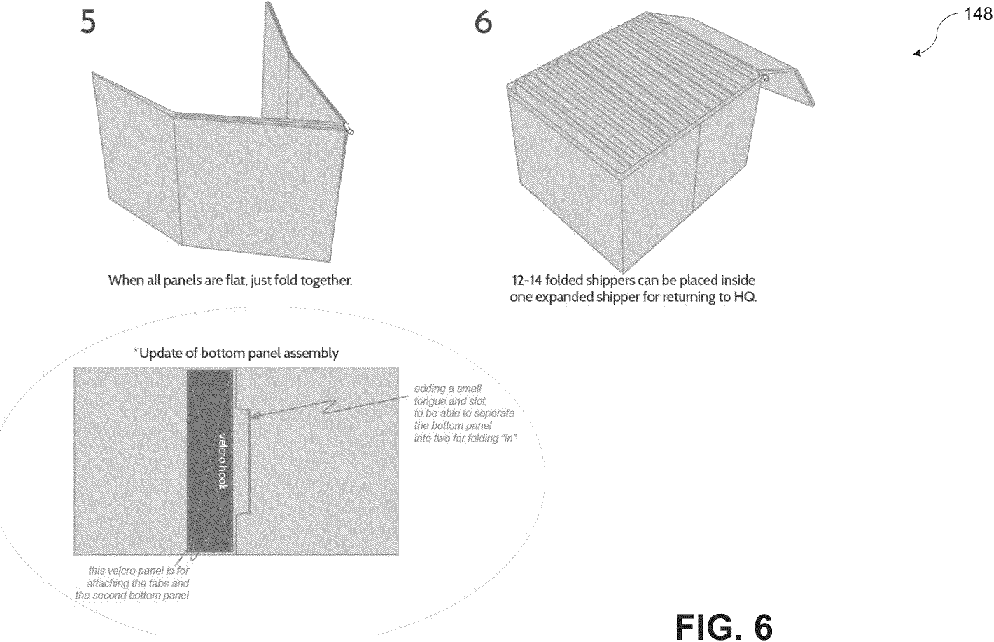

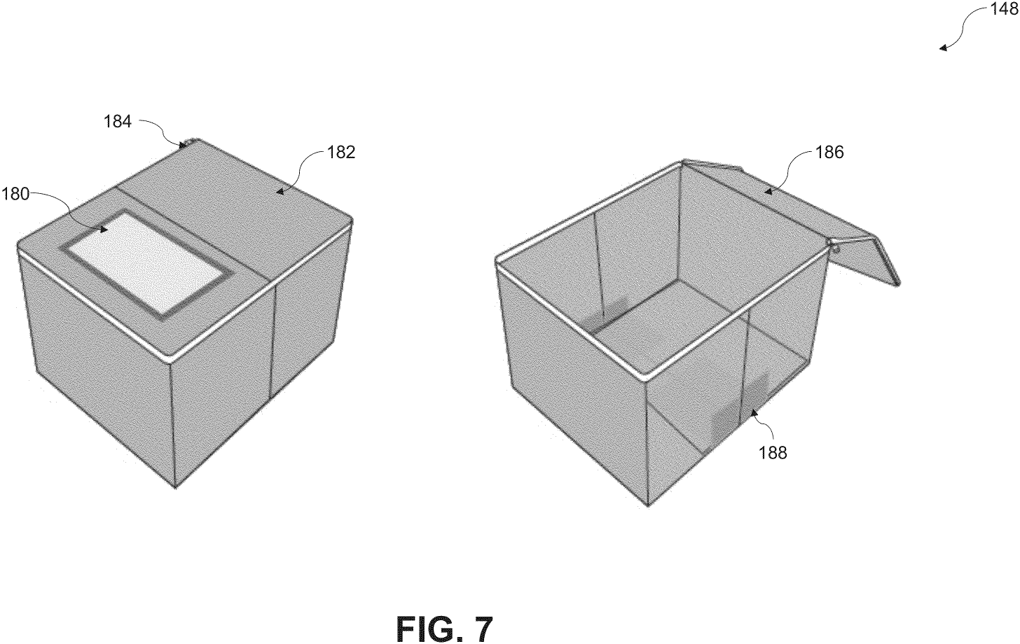

FIG. 5 and FIG. 6 depict schematic diagrams associated with how the reusable packaging 148 is foldable or collapsible for return. FIG. 7 depicts schematic diagrams of various components of the reusable packaging 148, such as: a transparent portion 180 affixed to the reusable packaging 148 (which may be configured to receive a shipping label or other documentation), a zipper or closure means 184 that is configured to maintain a closed state of the reusable packaging 148, and/or clear or transparent portions 188 for a shipping label window. Moreover, as shown in FIG. 7, the reusable packaging 148 may contain one or more materials, such as a recycled polyester material having a polyurethane coating 182 and a recycled polyester material 186. The reusable packaging 148 may also contain one or more materials for internal reinforcements, such as a non-woven polyester material. It should be appreciated that these materials are provided for illustrative purposes only and other materials are contemplated by Applicant.

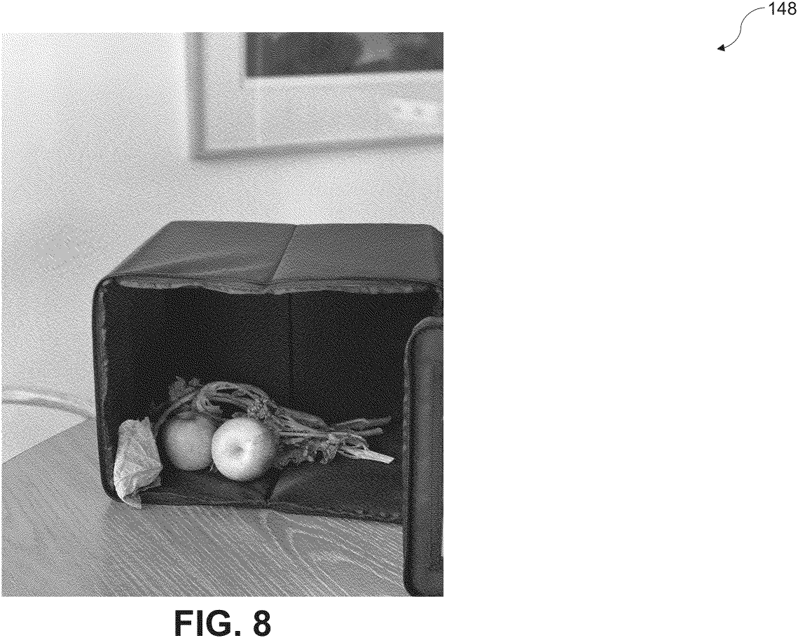

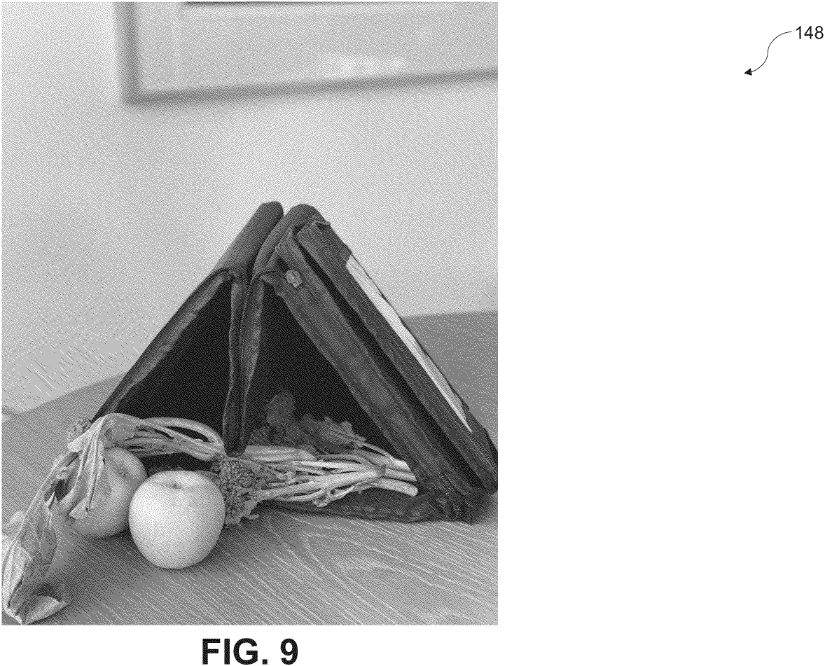

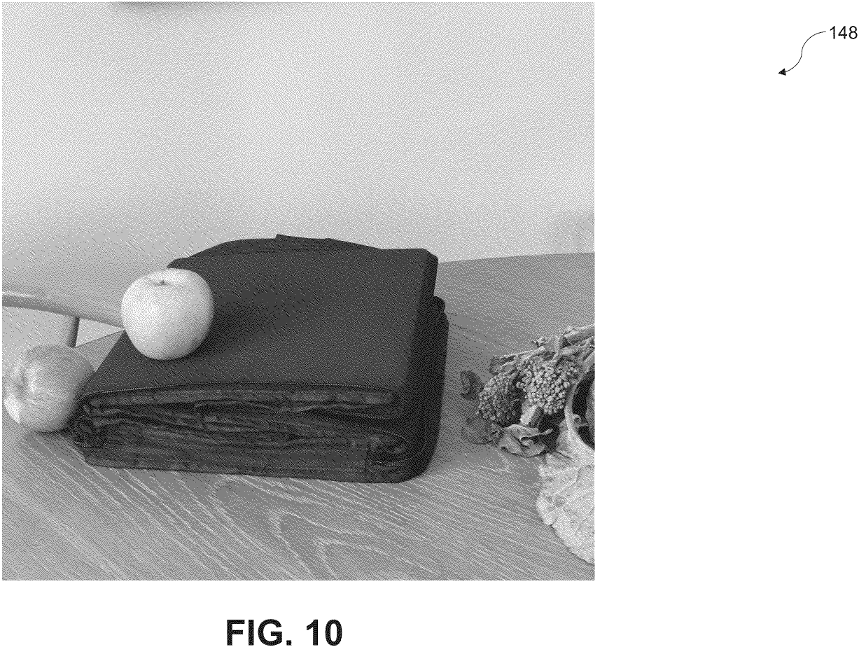

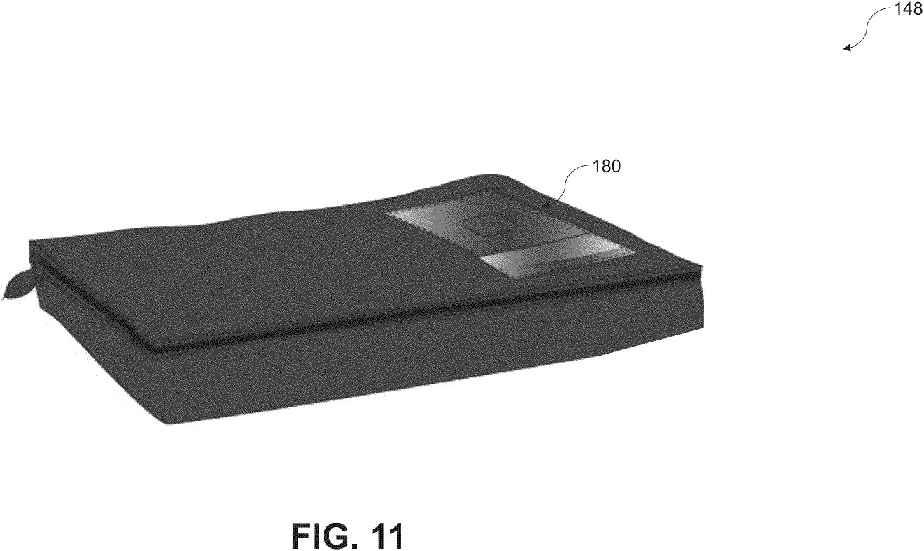

FIG. 8 - FIG. 10 depict images of how the reusable packaging 148 is foldable or collapsible for return. FIG. 11 depict schematic diagrams of a folded state of the reusable packaging 148. FIG. 11 also depicts the transparent portion 180 affixed to the reusable packaging 148, which may be configured to receive a shipping label or other documentation.

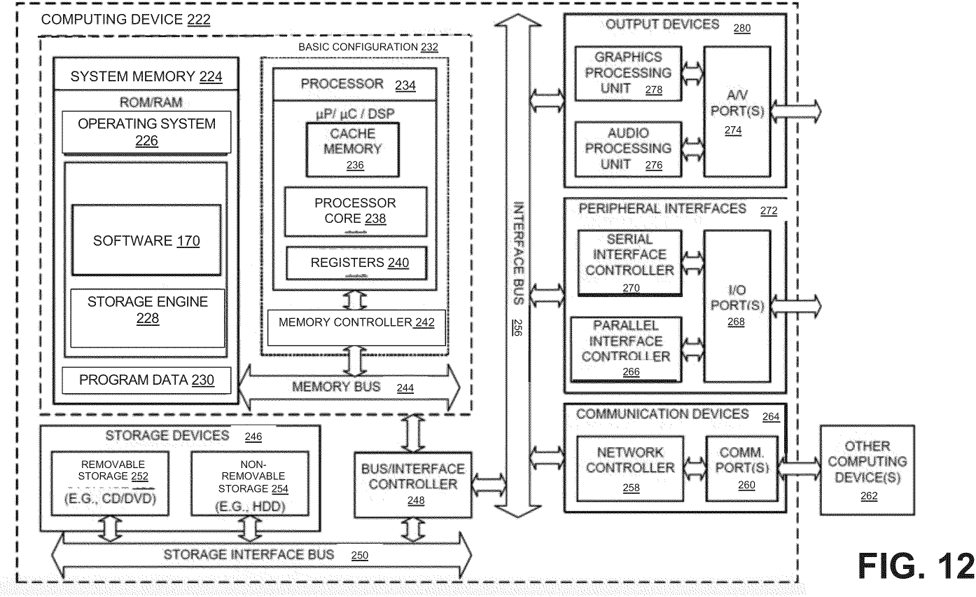

FIG. 12 is a block diagram of a computing device included within the computer system of FIG. 3. In some embodiments, the present invention may include a computer system, a method, and/or a computing device 222 (of FIG. 12). A basic configuration 232 of a computing device 222 is illustrated in FIG. 12 by those components within the inner dashed line. In the basic configuration 232 of the computing device 222, the computing device 222 includes a processor 234 and a system memory 224. In some examples, the computing device 222 may include one or more processors and the system memory 224. A memory bus 244 is used for communicating between the one or more processors 234 and the system memory 224.

Depending on the desired configuration, the processor 234 may be of any type, including, but not limited to, a microprocessor (µP), a microcontroller (µC), and a digital signal processor (DSP), or any combination thereof. Further, the processor 234 may include one more levels of caching, such as a level cache memory 236, a processor core 238, and registers 240, among other examples. The processor core 238 may include an arithmetic logic unit (ALU), a floating point unit (FPU), and/or a digital signal processing core (DSP Core), or any combination thereof. A memory controller 242 may be used with the processor 234, or, in some implementations, the memory controller 242 may be an internal part of the memory controller 242.

Depending on the desired configuration, the system memory 224 may be of any type, including, but not limited to, volatile memory (such as RAM), and/or non-volatile memory (such as ROM, flash memory, etc.), or any combination thereof. The system memory 224 includes an operating system 226, the software 112, one or more engines, and program data 230. The system memory 224 may also include a storage engine 228 that may store any information disclosed herein.

Moreover, the computing device 222 may have additional features or functionality, and additional interfaces to facilitate communications between the basic configuration 232 and any desired devices and interfaces. For example, a bus/interface controller 248 is used to facilitate communications between the basic configuration 232 and data storage devices 246 via a storage interface bus 250. The data storage devices 246 may be one or more removable storage devices 252, one or more non-removable storage devices 254, or a combination thereof. Examples of the one or more removable storage devices 252 and the one or more non-removable storage devices 254 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 256 facilitates communication from various interface devices (e.g., one or more output devices 280, one or more peripheral interfaces 272, and one or more communication devices 264) to the basic configuration 232 via the bus/interface controller 256. Some of the one or more output devices 280 include a graphics processing unit 278 and an audio processing unit 276, which are configured to communicate to various external devices, such as a display or speakers, via one or more A/V ports 274.

The one or more peripheral interfaces 272 may include a serial interface controller 270 or a parallel interface controller 266, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 268.

Further, the one or more communication devices 264 may include a network controller 258, which is arranged to facilitate communication with one or more other computing devices 262 over a network communication link via one or more communication ports 260. The one or more other computing devices 262 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 224, the one or more removable storage devices 252, and the one or more non-removable storage devices 254 are examples of the computer-readable storage media. The computer-readable storage media is a tangible device that can retain and store instructions (e.g., program code) for use by an instruction execution device (e.g., the computing device 222). Any such, computer storage media is part of the computing device 222.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 234 of a general purpose computer, special purpose computer, or other programmable data processing apparatus (e.g., the computing device 222) to produce a machine, such that the instructions, which execute via the processor 234 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 222), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer/computing device, partly on the user’s computer/computing device, as a stand-alone software package, partly on the user’s computer/computing device and partly on a remote computer/computing device or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

Another embodiment of the invention provides a method that performs the process steps on a subscription, advertising, and/or fee basis. That is, a service provider can offer to assist in one or more of the method steps described herein. In this case, the service provider can create, maintain, and/or support, etc. a computer infrastructure that performs the process steps for one or more recipient s. In return, the service provider can receive payment from the recipient (s) under a subscription and/or fee agreement, and/or the service provider can receive payment from the sale of advertising content to one or more third parties. The payment may be received on any basis, such as a daily basis, a weekly basis, a monthly basis, an annual basis, etc..

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A sensor-driven system for managing the logistics behind reusable objects, the system comprising:
a reusable package comprising:
one or more sensors configured to track parameters of the reusable package during a journey;
a battery component configured to supply power to the one or more sensors;
a transmitter configured to transmit the parameters to a receiver of a computing device;
a microcontroller configured to manage behavior of the one or more sensors; and
a near-field communication (NFC) antenna configured to allow a user to engage the computing device to interact with the one or more sensors;
the computing device comprising:
a receiver configured to:
receive the parameters from the transmitter of the reusable package; and
transmit the data to software; and
the software being configured to transmit the data to a database; and
the database being configured to store the parameters.

2. The sensor-driven system of claim 1, wherein the reusable package further comprises:
a thermometer that is configured to determine a current temperature within the reusable package.

3. The sensor-driven system of claim 1, wherein the reusable package further comprises:
a reed switch or a photocell that is configured to determine an open or closed status of the reusable package.

4. The sensor-driven system of claim 1, wherein the reusable package further comprises:
a global positioning system (GPS) component that is configured to determine a current location of the reusable package.

5. The sensor-driven system of claim 1, wherein the parameters are selected from the group consisting of: a tracking number associated with the reusable package, a current humidity level within the reusable package, a minimum humidity level within the reusable package during the journey, a maximum humidity level within the reusable package during the journey, an open status of the reusable package, a time period when the reusable package was opened, a current temperature within the reusable package, a minimum temperature within the reusable package during the journey, a maximum temperature within the reusable package during the journey, a current location of the reusable package, and how jostled the reusable package currently is or was during the journey.

6. The sensor-driven system of claim 1, wherein the transmitter is a Bluetooth transmitter or a Bluetooth Low Energy transmitter.

7. The sensor-driven system of claim 1, wherein each of the one or more sensors are selected from the group consisting of: a proximity capacitive sensor, a photoelectric sensor, an ambient light sensor, an optical proximity sensor, and a capacitive touch sensor.

8. The sensor-driven system of claim 1, wherein the transmitter is further configured to transmit the parameters to the database.

9. The sensor-driven system of claim 1, wherein the software is further configured to display information associated with the reusable package during the journey.

10. The sensor-driven system of claim 9, wherein the information is selected from the group consisting of: data analysis associated with the reusable package during the journey, sustainability statistics associated with the reusable package during the journey, logistics features associated with the reusable package during the journey, and predictive analytics associated with the reusable package.

11. The sensor-driven system of claim 9, wherein the sustainability statistics associated with the reusable package during the journey comprise environmental impact savings associated with the reusable packaging.

12. The sensor-driven system of claim 1, wherein the software allows for integration with APIs to automate order imports, automate shipping and return processes, and allow for direct recipient communication.

13. A reusable package comprising:
one or more sensors configured to track parameters of the reusable package during a journey;
a thermometer configured to determine a current temperature within the reusable package;
a reed switch or a photocell configured to determine an open or closed status of the reusable package;
a global positioning system (GPS) component configured to determine a current location of the reusable package;
a battery component configured to supply power to the one or more sensors;
a transmitter configured to transmit the parameters to a receiver of a computing device;
a microcontroller configured to manage behavior of the one or more sensors; and
a near-field communication (NFC) antenna configured to allow a user to engage the computing device to interact with the one or more sensors.

14. The reusable package of claim 13, wherein the receiver of the computing device is configured to receive the parameters from the transmitter of the reusable packaging and transmit the data to software.

15. The reusable package of claim 14, wherein the software is configured to transmit the data to a database, and wherein the database is configured to store the parameters.

16. The reusable package of claim 14, wherein the software is further configured to display information associated with the reusable package during the journey, and wherein the information is selected from the group consisting of: data analysis associated with the reusable package during the journey, sustainability statistics associated with the reusable package during the journey, logistics features associated with the reusable package during the journey, and predictive analytics associated with the reusable package.

17. The reusable package of claim 13, wherein the parameters are selected from the group consisting of: a tracking number associated with the reusable package, a current humidity level within the reusable package, a minimum humidity level within the reusable package during the journey, a maximum humidity level within the reusable package during the journey, an open status of the reusable package, a time period when the reusable package was opened, a current temperature within the reusable package, a minimum temperature within the reusable package during the journey, a maximum temperature within the reusable package during the journey, a current location of the reusable package, and how jostled the reusable package currently is or was during the journey.
